(19) United States
(12) Patent Application Publication
(10) Pub. No.: US 2009/0135097 A1
(43) Pub. Date: May 28, 2009

(54) PLASMA DISPLAY PANEL DEVICE

(75) Inventor: Sang Min HONG, Gumi-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/264,945

(22) Filed: Nov. 5, 2008

(30) Foreign Application Priority Data
Nov. 15, 2007 (KR) 10-2007-0116680
Nov. 15, 2007 (KR) 10-2007-0116681
Nov. 15, 2007 (KR) 10-2007-0116682

(51) Int. Cl. G09G 3/28

(52) U.S. Cl. 345/60

(57) ABSTRACT

The present invention relates to a plasma display panel device. In the plasma display panel device, a first electrode formed on an upper substrate of a plasma display panel is formed in a single layer, wherein the first electrode includes an electrode line and a protruding electrode extending from the electrode line, wherein the breadth of the lower end of the protruding electrode, located near the electrode line, is about 0.7 times to about 4.5 times the breadth of the upper end of the protruding electrode.

The plasma display panel device may reduce manufacturing costs of the plasma display panel, and reduce the incidence of uneven discharge between the scan electrode and the sustain electrode, which in turn may improve image quality of the panel.

### CROSS-REFERENCE TO RELATED APPLICATION

This application claims priority to Korean patent application 10-2007-0116680, filed on Nov. 15, 2007, Korean patent application 10-2007-0116681, filed on Nov. 15, 2007 and Korean patent application 10-2007-0116682, filed on Nov. 15, 2007, the disclosure of which is incorporated by reference herein.

### BACKGROUND OF THE INVENTION

1. Technical Field

The present invention is directed to a plasma display panel device, and more specifically to a structure of electrodes included in a plasma display panel of a plasma display panel device.

2. Discussion of Related Art

In general, a plasma display panel includes an upper substrate and a lower substrate. Barrier ribs are positioned between the upper substrate and the lower substrate, and each of the barrier ribs defines a unit cell. An inert gas is injected in each unit cell, which consists of a primary discharge gas and a small amount of Xe, wherein the primary discharge gas includes any one of Ne, He, and a mixture of Ne and He. The inert gas emits vacuum ultraviolet rays when being discharged by a high frequency voltage, and the emitted vacuum ultraviolet rays excite phosphors formed in the barrier ribs to display an image. This plasma display panel may be made thinner and lighter, and therefore, it gains popularity as a next generation display.

In a general plasma display panel, a scan electrode and a sustain electrode are formed on the upper substrate, and these scan electrode and sustain electrode, respectively, have a structure in which a transparent electrode and a bus electrode that are made of expensive ITO (Indium Tin Oxide) are stacked on each other in order to ensure high aperture ratio of the panel.

Recently, a plasma display panel is developed, which is capable of providing viewers with sufficient visual perception and driving characteristics as well as saving manufacturing costs.

Therefore, there is a need of a plasma display panel device capable of improving the brightness of a displayed image as well as reducing manufacturing costs of the panel by removing necessity of transparent electrodes made of ITO.

### SUMMARY OF THE INVENTION

An exemplary embodiment of the present invention provides a plasma display panel device including an upper substrate; a first electrode and a second electrode formed on the upper substrate; a lower substrate arranged to face the upper substrate; and a third electrode formed on the lower substrate, wherein the first electrode is formed in a single layer, and the first electrode includes an electrode line to cross the third electrode and a protruding electrode that extends from the electrode line toward the second electrode, wherein the breadth of a lower end of the protruding electrode located near the electrode line is about 0.7 times to about 4.5 times the breadth of an upper end of the protruding electrode.

### BRIEF DESCRIPTION OF THE DRAWING

The present invention will become more apparent by describing in detail exemplary embodiments thereof with references to the attached drawings, in which:

FIG. 1 is a perspective view illustrating a plasma display panel according to an exemplary embodiment of the present invention;

FIG. 2 is a view illustrating an array of electrodes included in a plasma display panel according to an exemplary embodiment of the present invention;

FIG. 3 is a timing diagram illustrating a time-division driving method of a plasma display panel according to an exemplary embodiment of the present invention, wherein one frame is divided into plural sub fields;

FIG. 4 is a timing diagram illustrating a driving signal of driving a plasma display panel according to an exemplary embodiment of the present invention;

FIGS. 5 to 13 are views illustrating structures of electrodes arranged on an upper substrate included in a plasma display panel according to an exemplary embodiment of the present invention; and

FIG. 14 is a graph illustrating a relationship between the distances d1 and d2, and discharge start voltage according to measured results shown in Table 1.

### DETAILED DESCRIPTION OF EXEMPLARY EMBODIMENTS

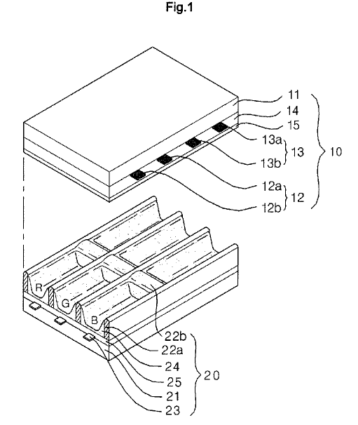

Hereinafter, exemplary embodiments of the present invention will be described with reference to accompanying drawings. FIG. 1 is a perspective view illustrating a plasma display panel according to an exemplary embodiment of the present invention.

Referring to FIG. 1, the plasma display panel includes an upper panel 10 and a lower panel 20 that are joined to each other with a predetermined interval.

The upper panel 10 includes an upper substrate 11 on which a maintaining electrode pair 12 and 13 is formed that includes a scan electrode 12 and a sustain electrode 13, each of which is separated from the other depending on its functions. The maintaining electrode pair 12 and 13 is covered with an upper dielectric layer 14 which limits a discharge current and insulates one maintaining electrode pair from another. A protection layer 15 is arranged on the upper dielectric layer 204 to protect the upper dielectric layer 14 from sputtering of charged particles created upon gas discharge and raises emission efficiency of secondary electrons.

A discharge gas is injected in a discharge space partitioned by the upper substrate 11, a lower substrate 21, and a barrier rib 22. The discharge gas may contain Xe more than 10%. In a case where Xe is contained in the discharge gas by the above mixing ratio, the discharge/emission efficiency and brightness of the plasma display panel may be improved.

The lower panel 20 includes a lower substrate 21 on which the barrier rib 22 is formed to define the discharge space, i.e. discharge cell. An address electrode 23 is formed on the lower substrate 21 to cross the maintaining electrode pair 12 and 13. A phosphor layer 24 is applied on the surface of the lower dielectric layer 25 and the barrier rib 22. The phosphor layer 24 is excited by ultraviolet rays generated upon gas discharge to emit visible rays.

The barrier rib 22 includes a vertical barrier rib 22a, which is arranged in parallel with the address electrode 23, and a horizontal barrier rib 22b, which is arranged to cross the address electrode 23. The barrier rib 22 physically defines the discharge cell and prevents ultraviolet rays and visible rays generated by discharge from leaking to neighboring discharge cells.

In the plasma display panel according to an exemplary embodiment of the present invention, the maintaining electrode pair 12 and 13 is made only of an opaque metal. For instance, the maintaining electrode pair may be made not of ITO (Indium Tin Oxide), which is conventionally used for a transparent electrode, but of Ag, Cu, or Cr, which is conventionally used for a bus electrode. That is, the maintaining electrode pair 12 and 13 is formed in a single bus electrode layer without the conventional ITO electrode.

For example, the maintaining electrode pair 12 and 13 may be made of Ag that may be photosensitive. The maintaining electrode pair 12 and 13 may be darker in color and lower in transmittance than the upper dielectric layer 14 or lower dielectric layer 14. The phosphor layers 24 applied in red, green, and blue discharge cells may be equal or different in pitch to/from each other. In case that the phosphor layers 24 are different in pitch from each other, the pitch of the green discharge cell may be larger than the pitch of the red discharge cell, and smaller than the pitch of the blue discharge cell.

As shown in FIG. 1, the maintaining electrode pair 12 and 13 may be formed to have plural electrode lines. That is, the first sustain electrode 12 may include two electrode lines 12a and 12b, and the second sustain electrode 13 may two electrode lines 13a and 13b that are arranged symmetrically with the first sustain electrode 12 with respect to the horizontal barrier rib 22b.

The first and second sustain electrodes 12 and 13 may be a scan electrode and a sustain electrode, respectively, taking into consideration aperture ratio and discharge diffusion efficiency according to usage of the opaque maintaining electrode pair 12 and 13. That is, an electrode line whose width is narrow is used considering aperture ratio, and plural electrode lines are used considering discharge diffusion efficiency. At this time, the number of electrode lines may be determined considering both of aperture ratio and discharge diffusion efficiency.

The structure of the plasma display panel shown in FIG. 1 is only an example of the structure of the plasma display panel according to an exemplary embodiment of the present invention, and the present invention is not limited thereto. For example, a black matrix (not shown) may be arranged on the upper substrate 11 to absorb external light to reduce reflection of the external light, and improve purity and contrast ratio of the upper substrate 11. The black matrix (not shown) may be configured removably or integrally.

Although the barrier rib shown in FIG. 1 is configured in a closing type, where a discharge cell is closed by the vertical barrier rib 22a and the horizontal barrier rib 22b, the present invention is not limited thereto. For example, the barrier rib may be configured is a stripe type which includes only vertical barrier ribs, or in a fish-bone type where protrusions are projected from the vertical barrier rib with a predetermined interval.

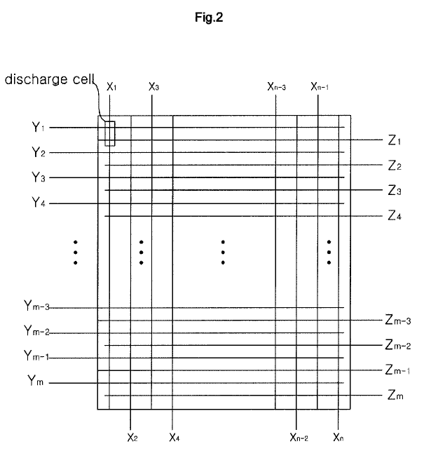

FIG. 2 is a view illustrating an array of electrodes included in a plasma display panel according to an exemplary embodiment of the present invention, wherein plural discharge cells included in the plasma display panel may be arranged in a matrix pattern. Plural discharge cells are arranged near the intersections of scan electrode lines Y1 to Ym and sustain electrode lines Z1 to Zm, and address electrode lines X1 to Xn. The scan electrode lines Y1 to Ym may be driven sequentially or simultaneously, and the sustain electrode lines Z1 to Zm may be driven simultaneously. The address electrode lines X1 to Xn may be driven sequentially. The address electrode lines X1 to Xn may be divided into odd-numbered address electrode lines and even-numbered address electrode lines for driving.

The array of electrodes shown in FIG. 2 is only an example of array of electrodes in the PDP according to an exemplary embodiment of the present invention. Therefore, the present invention is not limited to the array of electrodes and driving method shown in FIG. 2. For example, the present invention may employ a dual scan method, where two of the scan electrode lines Y1 to Ym are simultaneously scanned. Also, the address electrode lines X1 to Xn may be divided in upper and lower parts or in left and right parts with respect to a central axis of the panel for driving.

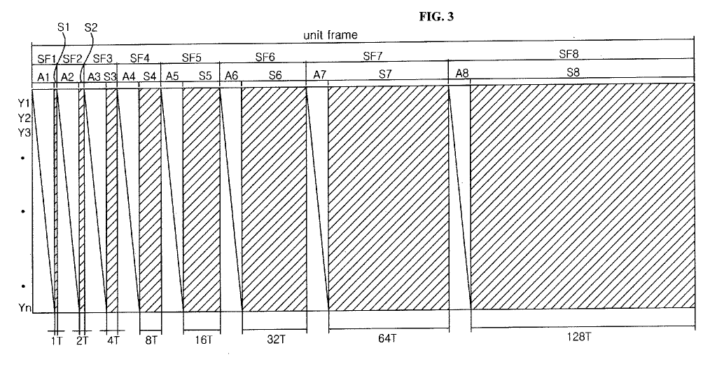

FIG. 3 is a timing diagram illustrating a time-division driving method of a plasma display panel according to an exemplary embodiment of the present invention, wherein one frame is divided into plural sub fields. A unit frame may be separated into, e.g. eight subfields SF1 to SF8 for time-division gray scale display. Each of the subfields SF1 to SF8 includes a reset period (not shown), an address period A1 to A8, and a sustain period S1 to S8.

In accordance with an exemplary embodiment of the present invention, a reset period may be omitted from at least one of the plural subfields. For example, the reset period may exist only within the first subfield, or only within the first subfield and a subfield positioned between the first subfield and the last subfield.

During each address period A1 to A8, a display data signal is applied to the address electrode X and its corresponding scan pulse is sequentially applied to each scan electrode Y.

During each sustain period S1 to S8, a sustain pulse is alternately applied to the scan electrode Y and the sustain electrode Z, so that sustain discharge occurs in the discharge cells in which wall charges are generated during the address period A1 to A8.

The brightness of the PDP is in proportion to the number of sustain discharge pulses generated during the sustain periods S1 to S8 occupying a unit frame. In a case where one frame embodying one image is represented as eight subfields and 256 gray scales, the number of sustain pulses may be differently assigned to each subfield in the ratio of 1, 2, 4, 8, 16, 32, 64, and 128. The brightness of 133 grays scales may be achieved by causing a sustain discharge while addressing cells during subfields SF1, SF3, and SF8.

The number of sustain discharges assigned to each subfield may be determined according to weight value of subfields in an automatic power control (APC) stage. Although a case has been described in FIG. 3 where one frame is divided into eight subfields, the present invention is not limited thereto, and the number of subfields constituting one frame may be varied depending on design and specifications. For example, one frame may be separated into more than eight subfields, such as 12 subfields and 16 subfields in order to drive the PDP.

Also, the number of sustain discharges assigned to each subfield may change variously considering gamma properties or panel characteristics. For example, the degree of gray scale assigned to subfield SF4 may be lowered from 8 to 6, and the degree of gray scale assigned to subfield 6 may be raised from 32 to 34.

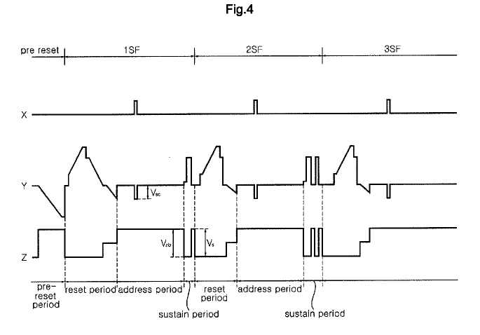

FIG. 4 is a timing diagram illustrating a driving signal of driving a plasma display panel according to an exemplary embodiment of the present invention.

Referring to FIG. 4, each subfield may include a pre-reset period, a reset period, an address period, and a sustain period. The pre-reset period generates positive wall charges on the scan electrodes Y and negative wall charges on the sustain electrodes Z. The reset period initializes the overall discharge cells using the distribution of the wall charges formed during the pre-reset period. The address period selects discharge cells. The sustain period sustains discharge occurring in the selected discharge cells.

A reset period includes a set-up period and a set-down period. During the set-up period, a ramp-up waveform is simultaneously applied to the overall scan electrodes to cause a tiny discharge in the whole discharge cells, and as a consequence, wall charges are generated. During the set-down period, a ramp-down waveform, which falls from a positive voltage whose peak is lower than that of the ramp-up waveform, is simultaneously applied to the whole scan electrodes Y to cause an erase discharge in the overall discharge cells, and accordingly, unnecessary charges are erased from space charges and wall charges generated by set-up discharge.

During the address period, a scan signal having a negative scan voltage Vsc is sequentially to the scan electrodes, and at the same time, a positive data signal is applied to the address electrode X. An address discharge occurs by the voltage differential between the scan signal and the data signal and wall charges generated during the reset period, and therefore, a cell is selected. Meanwhile, a sustain bias voltage Vzb may be applied to the sustain electrode during the address period to raise the efficiency of address discharge.

During the address period, the plural scan electrodes Y may be grouped into two or more, and scan signals may be sequentially applied to the scan electrode groups. And, each scan electrode group may be divided again into two or more sub groups, and scan signals may be sequentially supplied to the sub groups. For example, the plural scan electrodes Y may be divided into a first group and a second group, and scan signals are sequentially supplied to scan electrodes included into the first group and then to scan electrodes included into the second group.

In accordance with an exemplary embodiment of the present invention, the plural scan electrodes Y may be divided into a first group including even-numbered scan electrodes and a second group including odd-numbered scan electrodes. In addition, the plural scan electrodes Y may be divided into a first group including scan electrodes located in an upper part of the panel and a second group including scan electrodes located in a lower part of the panel with respect of a central axis of the panel.

The scan electrodes included in the first group may be divided again into a first sub group including even-numbered scan electrodes and a second sub group including odd-numbered scan electrodes, or a first sub group including scan electrodes located in an upper part and a second sub group including scan electrodes located in a lower part with respect to a central line of the first group.

During the sustain period, a sustain pulse having a sustain voltage Vs is alternately applied to the scan electrode and the sustain electrode to cause a sustain discharge in a surface-discharge type between the scan electrode and the sustain electrode.

Out of plural sustain signals alternately supplied to the scan electrode and sustain electrode in the sustain period, the first sustain signal or the last sustain signal may be larger in pulse width than the other sustain signals.

After the sustain discharge, the subfield may further include an erase period to erase wall charges remaining on the scan electrode and the sustain electrode of On-state cells selected during the address period by causing a weak discharge between the scan electrode and the sustain electrode.

The erase period may be included in the overall subfields or some subfields, and an erase signal for causing a weak discharge may be applied to an electrode to which the last sustain pulse is not applied during the sustain period.

The erase signal may include a gradually rising ramp signal, a low voltage wide pulse, a high voltage narrow pulse, an exponential signal, or a half-sinusoidal pulse.

Plural pulses may be sequentially applied to the scan electrode and the sustain electrode to cause a weak discharge.

The driving waveforms shown in FIG. 4 are only an example of signals to drive the plasma display panel according to an exemplary embodiment of the present invention, and the present invention is not limited to the driving waveforms shown in FIG. 4. For example, the pre reset period may be omitted from the sub field, and the polarity and voltage level of the driving waveforms shown in FIG. 4 may be modified as necessary. And, the erase signal may be also applied to the sustain electrode in order to erase wall charges after the sustain discharge has been complete. Furthermore, the sustain signal may be applied to either of the scan electrode Y or the sustain electrode Z to cause a sustain discharge, which is called “single sustain driving”.

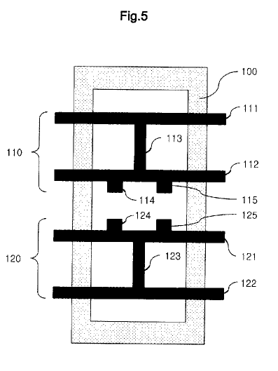

FIGS. 5 to 13 are views illustrating structures of electrodes arranged on an upper substrate included in a plasma display panel according to an exemplary embodiment of the present invention, wherein a single maintaining electrode pair is formed on the discharge cell included in the plasma display panel shown in FIG. 1.

Referring to FIG. 5, two sustain electrodes 110 and 120, which are provided in pair, are formed on a substrate symmetrically from each other with respect to a horizontal central axis of the discharge cell. The sustain electrode 110 may include at least two electrode lines 111 and 112 and two protruding electrodes 114 and 115 that are extended toward the horizontal central axis from the electrode line 112 that is located near the horizontal central axis. The sustain electrode 120 may include at least two electrode lines 121 and 122 and two protruding electrodes 124 and 125 that are extended toward the horizontal central axis from the electrode line 121 that is located near the horizontal central axis.

The sustain electrode 110 may further include a connection electrode 113 that connects the electrode line 111 to the electrode line 112. The sustain electrode 120 may further include a connection electrode 123 that connects the electrode line 121 to the electrode line 122.

The electrode lines 111, 112, 121, and 122 intersect the discharge cell and extend in a direction of the plasma display panel. Each of the electrode lines may be formed to have narrow width to improve aperture ratio of the discharge cell. Also, plural electrode lines, for example such as the electrode lines 111, 112, 121, and 122, are used to improve discharge diffusion efficiency. In this case, the number of the electrode lines may be determined considering the aperture ratio.

The protruding electrodes 114, 115, 124, and 125 lower a discharge start voltage upon driving of the plasma display panel. More specifically, since the protruding electrodes 114 and 115 are located near the protruding electrodes 124 and 125, respectively, that is, the interval between the protruding electrodes 114 and 124 or between the protruding electrodes 115 and 125 is small, a discharge may easily initiate even with a low discharge start voltage, and therefore, the discharge start voltage may be lowered. The discharge start voltage may refer to a voltage which permits a discharge to initiate when a pulse is supplied to at least one of the sustain electrodes 110 and 120.

The connection electrodes 113 and 123 help a discharge created by the protruding electrodes 114, 115, 124, and 125 to easily spread toward the electrode lines 111 and 122, respectively, which are located far from the horizontal central line of the discharge cell.

As described above, the discharge start voltage may be lowered by the protruding electrodes 114, 115, 124, and 125, and discharge diffusion efficiency may be improved by the plural electrode lines 111, 112, 121, and 122. A consequence is improvement in emission efficiency of the plasma display panel. Accordingly, the ITO transparent electrodes may be removed without reduction in brightness of the plasma display panel.

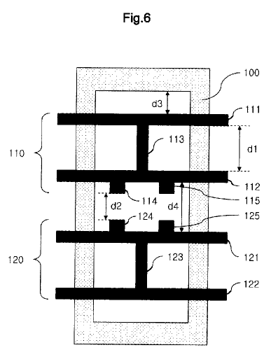

Referring to FIG. 6, as the distance d1 between two adjacent electrode lines 111 and 112 increases, the aperture ratio of the panel increase correspondingly, but the discharge diffusion efficiency may decrease. As the distance d2 between two protruding electrodes 114 and 124 that create discharge increases, the discharge start voltage may increase correspondingly.

Table 1 shows variation in discharge start voltage according to the distances d1 and d2.

TABLE 1

| d1 | d2 | Discharge start voltage |
|---|---|---|
| 250 | 30 | 192 V |
| 240 | 40 | 188 V |
| 230 | 50 | 180 V |
| 220 | 60 | 179 V |
| 210 | 70 | 179 V |
| 200 | 80 | 181 V |
| 190 | 90 | 180 V |
| 180 | 100 | 179 V |
| 175 | 105 | 187 V |
| 170 | 110 | 188 V |
| 165 | 115 | 190 V |
| 160 | 120 | 191 V |

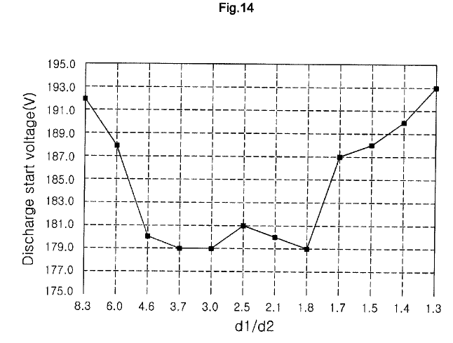

FIG. 14 depicts a relationship between the distances d1 and d2, and discharge start voltage according to measured results shown in Table 1.

Referring to Table 1 and FIG. 14, as the distances d1 and d2 decrease, the distance d1 decreases, and this leads to improvement in discharge diffusion efficiency. Accordingly, when the distance d1 is equal to 4.6 times the distance d2, the discharge start voltage decreases lower than 180V.

However, when the distance d1 is more than 1.8 times the distance d2, as the distance d2 increases, the discharge start voltage abruptly increases, for example more than 187V.

Therefore, when the distance d1 ranges from more than about 1.8 times to about 4.6 times the distance d2, the discharge start voltage may be stably decreased less than about 180V.

In addition, the distance d1 may be about 2.1 times to about 2.8 times the distance d2 in order to ensure aperture ratio of the panel to prevent lowering in brightness of the panel and permit discharge to be uniformly created in the entire areas of the discharge cell.

Assuming the length of the protruding electrodes 114 and 124 is 50 um to 100 um, it can be seen from Table 1 that when the distance d1 is about 0.6 times to about 1.5 times the distance d4 between the two different electrode lines 112 and 121, the discharge start voltage may be stably reduced less than about 180V.

Assuming the distance d2 is constant, the distance d1 may be in inverse-proportion to the distance between the electrode line 111 and the barrier rib 100. As described above, as the distance d1 increases, the discharge occurring area may increase, but the discharge diffusion efficiency may decrease.

In a case where a discharge takes place only in part of the discharge cell, deterioration in image quality, for example, spots may occur in an image displayed on the panel.

Accordingly, when the distance d1 is about 1 time to about 1.7 times the distance d3, a discharge may occur in the entire areas of the discharge cell, and this may prevent deterioration in image quality occurring in an image displayed on the panel.

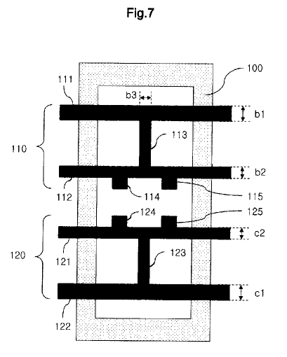

Referring to FIG. 7, the breadth b1 of the electrode line 111 may be different from the breadth b2 of the electrode line 112.

In a case where the amount of wall charges created by an address discharge is different at the electrode line 111 and the electrode line 112, the amount of light emitted by a sustain discharge may be different according to location of the two electrode lines 111 and 112, and accordingly, deterioration in image quality, for example, spots may occur in an image displayed on the panel.

For example, wall charges are created at the electrode line 111, which is located far from the horizontal central line out of the two electrode lines 111 and 112, by spreading of discharge, and therefore, the amount of wall charges created at the electrode line 111 may be smaller than the amount of wall charges created at the electrode line 112, which is located near the horizontal central line. Accordingly, the amount of wall charges created at the electrode line 111 may be similar to the amount of wall charges created at the electrode line 112 by having the breadth b1 larger than the breadth b2.

As described above, a discharge may uniformly occur in the entire areas of the discharge cell by having the amount of wall charges created at the electrode line 111 similar to the amount of wall charges created at the electrode line 112, and this may reduce deterioration in image quality that may take place in an image displayed on the panel.

Table 2 shows the brightness and incidence of spots in an image displayed on the panel according to variation in the breadths b1 and b2.

TABLE 2

| b1(μm) | b2(μm) | Incidence of spots | brightness(cd/m²) |
|---|---|---|---|
| 28 | 40 | ◯ | 485 |
| 32 | 40 | ◯ | 485 |
| 36 | 40 | ◯ | 484 |
| 40 | 40 | ◯ | 480 |
| 44 | 40 | X | 479 |
| 48 | 40 | X | 479 |
| 52 | 40 | X | 475 |
| 56 | 40 | X | 474 |
| 60 | 40 | X | 471 |
| 64 | 40 | X | 468 |
| 68 | 40 | X | 467 |
| 72 | 40 | X | 465 |
| 76 | 40 | X | 461 |
| 80 | 40 | X | 459 |
| 84 | 40 | X | 431 |
| 88 | 40 | X | 410 |
| 82 | 40 | X | 390 |
| 86 | 40 | X | 375 |

Referring to Table 2, when the breadth b1 is more than 44 um, deterioration in image quality, such as spots, does not occur in a displayed image. In a case where the breadth b1 is more than 80 um, however, the brightness of the displayed image abruptly decreases less than 460 cd/m².

Accordingly, when the breadth b1 is about 1.1 times to about 2 times the breadth b2, deterioration in image quality of the displayed image may be prevented and the improvement in brightness may be improved.

In addition, the breadth b1 may be about 1.15 times to about 1.5 times the breadth b2 so that the amount of wall charges created at the electrode line 111 may be similar to the amount of wall charges created at the electrode line 112 by increasing the amount of wall charges created at the electrode line 111 without greatly reducing the discharge diffusion efficiency.

As described above with reference to Table 1, the distance d1 may be about 180 um to about 230 um, and as described above with reference to Table 2, the breadth b1 may be about 44 um to about 80 um, and therefore, the distance d1 may be about 2.25 times to about 5.2 times the breadth b1.

By the above reasons, the breadth c1 of the electrode line 121 and the breadth c2 of the electrode line 122 may be different from each other within the above range.

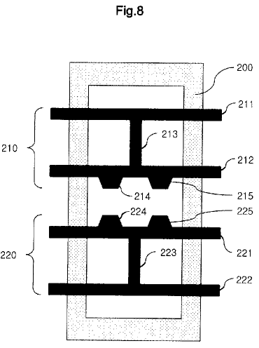

Referring to FIG. 8, the width w1 of the lower end of each of protruding electrodes 214, 215, 224, and 225 that are extended from electrode lines 212 and 221 may be different from the width w2 of its upper end. Accordingly, it can be possible to prevent the protruding electrodes 214, 215, 224, and 225 from being separated from the electrode lines 212 and 221, which may do damage to the plasma display panel.

The protruding electrodes 214, 215, 224, and 225 thusly configured may increase surface area by which a discharge may take place between the protruding electrodes 214 and 215, and the protruding electrodes 224 and 225, and this may lead to improvement in discharge efficiency.

Table 3 shows the incidence of damage to electrode and the incidence of spots in a displayed image according to variation in the width w1 of the lower end of the protruding electrode 214.

TABLE 3

| w1(μm) | w2(μm) | Incidence of damage to electrode | incidence of spots |
|---|---|---|---|
| 10 | 30 | ◯ | X |
| 15 | 30 | ◯ | X |
| 20 | 30 | ◯ | X |
| 25 | 30 | X | X |
| 30 | 30 | X | X |
| 35 | 30 | X | X |
| 40 | 30 | X | X |
| 45 | 30 | X | X |
| 50 | 30 | X | X |
| 55 | 30 | X | X |
| 60 | 30 | X | X |
| 65 | 30 | X | X |
| 70 | 30 | X | X |
| 75 | 30 | X | X |
| 80 | 30 | X | X |
| 85 | 30 | X | X |
| 90 | 30 | X | X |
| 100 | 30 | X | X |
| 105 | 30 | X | X |
| 110 | 30 | X | X |
| 115 | 30 | X | X |
| 120 | 30 | X | X |
| 125 | 30 | X | X |
| 130 | 30 | X | X |
| 135 | 30 | X | ◯ |
| 140 | 30 | X | ◯ |
| 145 | 30 | X | ◯ |
| 150 | 30 | X | ◯ |

Referring to Table 3, when the width w1 is 20 um, there does not occur any damage to the protruding electrode due to external pressure. In a case where the width w1 is more than 135 um, the distance between two adjacent protruding electrodes 214 and 224 is uneven, so that there may occur longitudinal stripe patterns on the displayed image.

Accordingly, when the width w1 is about 0.7 times to about 4.5 times the width w2, it can be possible to prevent any damage to the protruding electrode and reduce deterioration in image quality on the displayed image.

In addition, the width w1 may be about two times the width w2 to reduce the discharge start voltage and improve the discharge diffusion efficiency.

When the distance between the lower end of the protruding electrode 214 and the lower end of the protruding electrode 215 is about 0.9 times to about 2 times the width w1, it can be possible to ensure aperture ratio of the panel and uniformly create a discharge in the entire areas of the discharge cell.

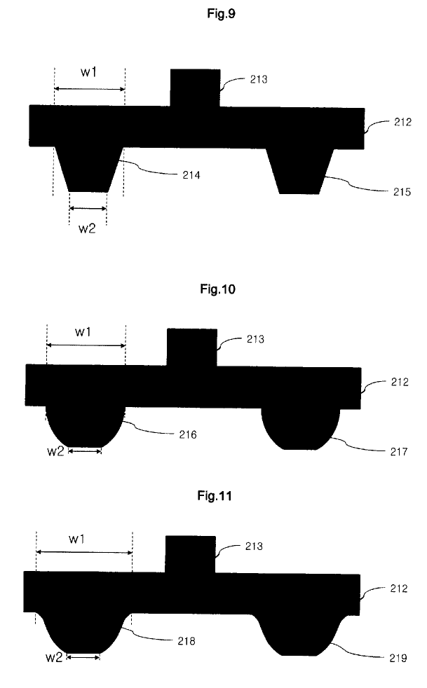

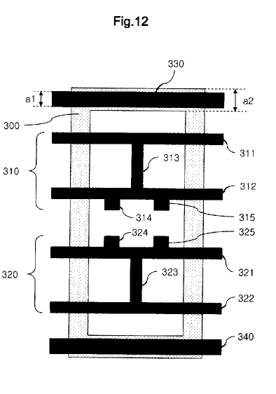

Referring to FIGS. 10 and 11, the surface area of protruding electrodes 216, 217, 218, and 219 for discharge may increase by making round both edges of upper end and lower end of the protruding electrodes 216, 217, 218, and 219, and this may lead to improvement in discharge efficiency.

Referring to FIG. 12, black matrixes 330 and 340 may be arranged on the barrier rib 300 to improve aperture ratio of the panel, wherein the width a1 of the black matrixes 330 and 340 may be smaller than the width a2 of the barrier rib 300.

The width a1 may be more than about 0.5 times the width a2 to improve contrast ratio as well as aperture ratio of the panel.

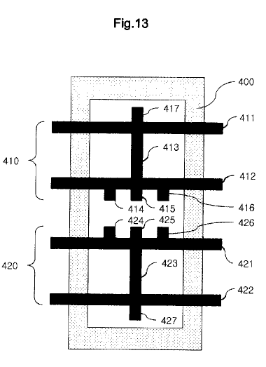

Referring to FIG. 13, the plasma display panel may further include protruding electrodes 417 and 427 that extend from electrode lines 411 and 422, respectively, which are located far from the horizontal central axis of the discharge cell.

The number of protruding electrodes 414, 415, 416, 424, 425, and 426 may be six or more, which are extended from electrode lines 412 and 421 that are located near the horizontal central axis of the discharge cell.

As described above, the plasma display panel device according to exemplary embodiments of the present invention may reduce manufacturing costs of the plasma display panel by removing necessity of transparent electrodes that are made of ITO, and reduce the incidence of uneven discharge between the scan electrode and the sustain electrode, which in turn may improve image quality of the panel, by having the ratio in width between the upper end and the lower end of the protruding electrode range from about 0.7 to about 4.5.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display panel device comprising an upper substrate; a first electrode and a second electrode formed on the upper substrate; a lower substrate arranged to face the upper substrate; and a third electrode formed on the lower substrate, wherein
the first electrode is formed in a single layer, and the first electrode includes first and second electrode lines to cross the third electrode, and a protruding electrode that extends from the first electrode located near the center of a discharge cell toward the center of the discharge cell, wherein
the first and second electrode lines are different in breadth from each other.

2. The plasma display panel device of claim 1, wherein
the breadth of the second electrode line is larger than the breadth of the first electrode line.

3. The plasma display panel device of claim 1, wherein
the breadth of the second electrode line is about 1.1 times to about 2 times the breadth of the first electrode line.

4. The plasma display panel device of claim 1, wherein
the breadth of the second electrode line is about 1.15 times to about 1.5 times the breadth of the first electrode line.

5. The plasma display panel device of claim 1, wherein
a distance between the first electrode line and the second electrode line is about 2.25 times to about 5.2 times the breadth of the first electrode line.

6. The plasma display panel device of claim 1, wherein
a horizontal barrier is formed on the lower substrate to cross the third electrode, wherein the distance between the first electrode line and the second electrode line is about 1 time to about 1.7 times the distance between the second electrode line and the horizontal barrier rib.

7. The plasma display panel device of claim 1, wherein
the first electrode includes first and second protruding electrodes extending from the first electrode line, wherein
a distance between a lower end of the first protruding electrode and a lower end of the second protruding electrode is about 0.9 times to about 2 times the breadth of the lower end of the first protruding electrode.

8. The plasma display panel device of claim 1, wherein
a horizontal barrier rib is formed on the lower substrate to cross the third electrode, wherein a breadth of the horizontal barrier rib is larger than a breadth of a black matrix arranged on the horizontal barrier rib.

9. A plasma display panel device comprising an upper substrate; a first electrode and a second electrode formed on the upper substrate; a lower substrate arranged to face the upper substrate; and a third electrode formed on the lower substrate, wherein
the first electrode is formed in a single layer, and the first electrode includes first and second electrode lines to cross the third electrode, and a protruding electrode that extends from the first electrode located near the center of a discharge cell toward the center of the discharge cell, wherein
the first and second electrode lines are different in breadth from each other, and a breadth of a lower end of the protruding electrode located near the electrode lines is about 0.7 times to about 4.5 times the breadth of an upper end of the protruding electrode.

10. The plasma display panel device of claim 9, wherein
the breadth of the lower end of the protruding electrode is about 2 times to about 4.5 times the breadth of the upper end of the protruding electrode.

11. The plasma display panel device of claim 9, wherein
both edges of the upper end and the lower end of the protruding electrode are rounded.

12. The plasma display panel device of claim 9, wherein
the first electrode includes first and second electrode lines formed to cross the third electrode, wherein a distance between the first electrode line and the second electrode line is about 2.25 times to about 5.2 times the breadth of the first electrode line.

13. The plasma display panel device of claim 9, wherein
a horizontal barrier rib is formed on the lower substrate to cross the third electrode, and the first electrode includes first and second electrode lines formed to cross the third electrode, wherein
a distance between the first electrode line and the second electrode line is about 1 time to about 1.7 times the distance between the first electrode and the horizontal barrier rib.

14. The plasma display panel device of claim 9, wherein
the first electrode includes first and second protruding electrodes extending from the electrode line toward the second electrode, wherein
a distance between a lower end of the first protruding electrode and a lower end of the second protruding electrode is about 0.9 times to about 2 times the breadth of the lower end of the first protruding electrode.

15. The plasma display panel device of claim 9, wherein
a horizontal barrier rib is formed on the lower substrate to cross the third electrode, wherein a breadth of the horizontal barrier rib is larger than a breadth of a black matrix arranged on the horizontal barrier rib.

16. A plasma display panel device comprising an upper substrate; a first electrode and a second electrode formed on the upper substrate; a lower substrate arranged to face the upper substrate; and a third electrode formed on the lower substrate, wherein
each of the first electrode and the second electrode is formed in a single layer, and the first electrode includes first and second electrode lines to cross the third electrode, and a protruding electrode that extends from the first electrode located near the center of a discharge cell toward the center of the discharge cell, wherein
the first and second electrode lines are different in breadth from each other, and a distance between the first and second electrode lines is about 1.8 times to about 4.6 times the distance between a protruding electrode included in the first electrode and a protruding electrode included in the second electrode.

17. The plasma display panel device of claim 16, wherein
the distance between the first electrode line and the second electrode line is about 2.1 times to about 2.8 times the distance between the protruding electrodes.

18. The plasma display panel device of claim 16, wherein
a breadth of a lower end of the protruding electrode located near the first electrode line is about 0.7 times to about 4.5 times a breadth of an upper end of the protruding electrode.

19. The plasma display panel device of claim 16, wherein
the distance between the first electrode line and the second electrode line is about 2.25 times to about 5.2 times the breadth of the first electrode line.

20. The plasma display panel device of claim 16, wherein
a horizontal barrier is formed on the lower substrate to cross the third electrode, and the distance between the first electrode line and the second electrode line is about 1 time to about 1.7 times the distance between the second electrode line and the horizontal barrier rib.
